(19) United States
(12) Patent Application Publication
(10) Pub. No.: US 2005/0013610 A1
(43) Pub. Date: Jan. 20, 2005

(54) Optical performance monitoring between terminal equipment and an optical interface to an optical submarine transmission line

(76) Inventors: Stephen G. Evangelides JR., Red Bank, NJ (US); Jonathan A. Nagel, Brooklyn, NY (US); David L. Wilson, Little Silver, NJ (US)

Correspondence Address: MAYER, FORTKORT & WILLIAMS, PC, 251 NORTH AVENUE WEST, 2ND FLOOR, WESTFIELD, NJ, 07090, US

(21) Appl. No.: 10/792,268

(22) Filed: Mar. 3, 2004

Related U.S. Application Data
(63) Continuation-in-part of application No. 10/621,028, filed on Jul. 16, 2003.

(51) Int. Cl. H04B 10/08

(52) U.S. Cl. 398/33

(57) ABSTRACT

A method and apparatus is provided for monitoring optical signal quality between land-based terminal equipment and an undersea optical transmission path. The method begins by receiving an analog optical signal in which information is embodied in digital form from either of the terminal equipment or the undersea optical transmission path. The method continues by measuring a parameter such as the Q-factor, which reflects signal quality by analysis of the analog optical signal and not the information digitally embodied therein.

### RELATED APPLICATIONS

This application is a continuation-in-part of U.S. patent application Ser. No. 10/621,028 entitled “Method and Apparatus for Providing a Terminal Independent Interface Between a Terrestrial Optical Terminal and an Undersea Optical Transmission Path.”

This application is related to U.S. patent application Ser. No. 10/621,115 entitled “Method and Apparatus for Performing System Monitoring in a Terminal Independent Interface Located Between a Terrestrial Optical Terminal and an Undersea Optical Transmission Path.”

### FIELD OF THE INVENTION

The present invention relates generally to optical transmission systems, and more particularly to an optical interface for providing communication and performance monitoring between an optical terminal and an undersea optical transmission path.

### BACKGROUND OF THE INVENTION

One type of highly specialized optical transmission network is an undersea or submarine optical transmission system in which a cable containing optical fibers is installed on the ocean floor. The cable contains optical fibers that carry Wavelength Division Multiplexed (WDM) optical signals between land-based terminals. The terminals contain power supplies for the undersea cable, transmission equipment to insert and remove WDM signals from the fibers and associated monitoring and control equipment. Over long distances the strength and quality of a transmitted optical signal diminishes. Accordingly, repeaters are located along the cable, which contain optical amplifiers to provide amplification to the optical signals to overcome fiber loss.

The design of the land-based terminals (the “dry-plant”) and the undersea cable and repeaters (the “wet plant”) are typically customized on a system-by-system basis and employ highly specialized terminals to transmit data over the undersea optical transmission path. For this reason the wet and dry plants are typically provided by a single entity that serves as a systems integrator. As a result all the elements of the undersea system can be highly integrated to function together. For example, all the elements can exchange information and commands in order to monitor service quality, detect faults, and locate faulty equipment. In this way the quality of service from end to end (i.e., from one land-based terminal to another) can be guaranteed. Moreover, since there is a single systems integrator involved, the system operator always knows who to contact in the event of a failure.

Recently, undersea optical transmission systems have been proposed in which the wet plant can be designed independently of the dry plant. Specifically, the wet plant is designed as an independent, stand-alone network element and is transparent to the dry plant. In this way the wet plant can accommodate a wide variety of different land-based terminals. In order to achieve such universal transparency, an optical interface device is provided between the wet plant and the terminals. One problem with this arrangement is that it must still provide the same end-to-end quality of service guarantee as a conventional system that is provided by a single vendor. That is, the system must be able to locate the cause of a fault anywhere within it and assign the fault to a specific element.

### SUMMARY OF THE INVENTION

In accordance with the present invention, a method and apparatus is provided for monitoring optical signal quality between land-based terminal equipment and an undersea optical transmission path. The method begins by receiving an analog optical signal in which information is embodied in digital form from either of the terminal equipment or the undersea optical transmission path. The method continues by measuring a parameter reflecting signal quality by analysis of the analog optical signal and not the information digitally embodied therein.

In accordance with one aspect of the invention, the parameter is a Q-factor.

In accordance with another aspect of the invention, the parameter comprises a signal spectrum.

In accordance with another aspect of the invention, a method is provided for providing optical-level connectivity between land-based terminal equipment and an undersea optical transmission path. The method begins by receiving an analog optical signal in which information is embodied in digital form from the terminal equipment and measuring a parameter reflecting signal quality by analysis of the analog optical signal and not the information digitally embodied therein. At least one optical-level signal process is performed on the analog optical signal and the analog optical signal is directed onto the undersea optical transmission path.

In accordance with another aspect of the invention, the optical-level signal process is selected from the group consisting of gain equalization, bulk dispersion compensation, optical gain, Raman amplification, dispersion slope compensation, PMD compensation, and dummy channel insertion.

In accordance with another aspect of the invention, Raman amplification is supplied to the analog optical signal.

In accordance with another aspect of the invention, a status of the undersea optical transmission path is monitored.

In accordance with another aspect of the invention, the monitoring step is performed with a COTDR.

In accordance with another aspect of the invention, the monitoring step employs an autocorrelation technique.

In accordance with another aspect of the invention, an optical interface device is provided for providing optical-level connectivity between land-based terminal equipment and an undersea optical transmission path. The optical interface device includes a first arrangement for receiving an analog optical signal in which information is embodied in digital form from the terminal equipment, a second arrangement for measuring a parameter reflecting signal quality by analysis of the analog optical signal and not the information digitally embodied therein, a third arrangement for performing at least one optical-level signal process on the analog optical signal, and a fourth arrangement for directing the analog optical signal onto the undersea optical transmission path.

### BRIEF DESCRIPTION OF THE DRAWINGS

FIG. 1 shows an example of an undersea optical transmission system that employs an optical interface device constructed in accordance with the present invention to provide transparency between the terminal equipment and the wet plant.

FIG. 2 shows a block diagram of one embodiment of optical interface device in which the present invention may be employed.

### DETAILED DESCRIPTION

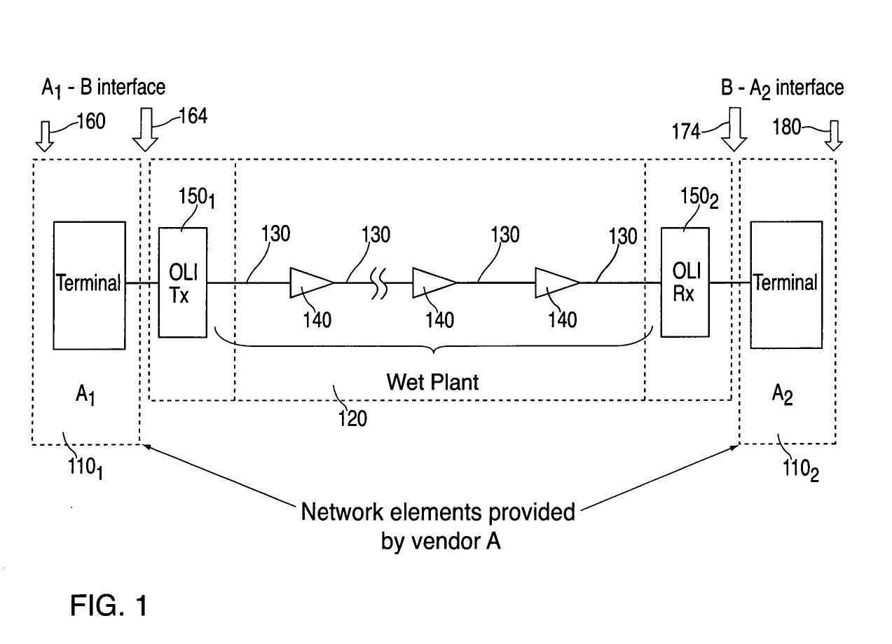

FIG. 1 shows an example of an undersea optical transmission system that employs an optical interface device to provide transparency between the terminal equipment and the wet plant. The system consists of terminal equipment 110₁ and 110₂ that communicate with one another over a wet plant 120 consisting of optical transmission spans 130 connected by repeaters 140. An optical interface device 150 provides the connectivity between the wet plant 120 and each terminal 110. Specifically, optical interface device 150₁ provides optical-level connectivity to terminal equipment 110₁ and optical interface device 150₂ provides optical-level connectivity to terminal equipment 110₂. The wet plant 120 and the optical interface devices 150 will generally be provided by a single vendor or system integrator while the terminal equipment 110₁ and 110₂ may be provided by a different vendor. In this case, in the event of a failure, the system operator must be able to determine which vendor to contact for repairs to be made.

The terminal equipment 110 will typically perform any necessary optical-to-electrical conversion, FEC processing, electrical-to-optical conversion, and optical multiplexing. The terminal equipment 110 may also perform optical amplification, optical monitoring that is designed for the terrestrial optical network, and network protection. Examples of terminal equipment that are currently available and which may be used in connection with the present invention include, but are not limited to, the Nortel LH1600 and LH4000, Siemens MTS 2, Cisco 15808 and the Ciena CoreStream long-haul transport products. The terminal equipment may also be a network router in which Internet routing is accomplished as well the requisite optical functionality. Moreover, the terminal equipment that is employed may conform to a variety of different protocol standards, such as SONET/SDH ATM and Gigabit Ethernet, for example.

The optical interface device 150 provides the signal conditioning and the additional functionality necessary to transmit the traffic over an undersea optical transmission cable. One example of suitable interface device is disclosed in U.S. application Ser. No. 10/621,028, which is hereby incorporated by reference in its entirety. As discussed in the aforementioned reference, the optical interface device disclosed therein receives the optical signals from terminal equipment such as a SONET/SDH transmission terminal either as individual wavelengths on separate fibers or as a WDM signal on a single fiber. The interface device provides the optical layer signal conditioning that is not provided by the SONET/SDH terminals, but which is necessary to transmit the optical signals over the undersea transmission path. The signal conditioning that is provided may include, but is not limited to, gain equalization, bulk dispersion compensation, optical amplification, multiplexing, Raman amplification, dispersion slope compensation, polarization mode dispersion (PMD) compensation, performance monitoring, signal load balancing (e.g., dummy channel insertion), or any combination thereof. The optical interface device may also include line monitoring equipment such as a COTDR arrangement, an autocorrelation arrangement, or other techniques that use in-band or out-of band probe signals to determine the status and health of the transmission path. Additionally, the optical interface device may supply pump power to the transmission path so that Raman amplification can be imparted to the optical signals.

The undersea transmission system shown in FIG. 1 must provide the same end-to-end quality of service guarantee as a conventional system that is provided by a single vendor. This requires the system to be able to locate the cause of a fault anywhere within the system and assign it to a specific element. That is, it is necessary to be able to locate a fault that may arise in any of the elements shown in FIG. 1 between interface 164 and interface 174.

Presumably, the transponders in the terminal equipment 110 have the ability to locate and diagnose their own faults. The wet plant 120 and optical interface devices 150 generally do not have access to the data payload in the optical signals and thus cannot use such data to monitor signal quality such as by examining FEC or other telemetry information. Thus, the wet plant 120 and the optical interface devices 150 must be able to detect service-effecting faults within themselves and they must also be able to monitor the quality of the optical signals as they enter and exit these elements (i.e., as they traverse interfaces 164 and 174). The health and status of the wet plant 120 can be monitored by a performance monitor such as a COTDR that is located in the optical interface device 150. One example of an optical interface device incorporating such a performance monitor is disclosed in co-pending U.S. patent Appl. Serial No. [Docket No. 19]. Accordingly, there remains a need to monitor the signal quality as it crosses interface 164 and then again as it crosses interface 174.

In accordance with the present invention, the optical interface devices 150 are provided with the ability to monitor the signal quality as the signals are received from or transmitted to the terminal equipment 110. Since, as previously mentioned, the optical interface devices 150 do not have access to the payload data, traditional techniques of accessing signal quality such as by measuring the Bit Error Ratio (BER) are not available. Instead, a technique should be employed that analyzes the analog optical signal itself to determine signal quality, which is independent of data format and bit rate.

In one embodiment of the invention, the optical interface devices 150 measure the Q-factor of each channel in the optical signals being communicated between the optical interface devices 150 and the terminal equipment 110. The Q-factor is a well-known measure of the quality of the analog optical signal. An important advantage of the Q-factor is that it can be determined independent of data format and bit rate. The Q-factor gives a measure of propagation impairments caused by optical noise, non-linear effects, polarization effects, chromatic dispersion and the like. Mathematically, the Q-factor is defined by the difference of the mean values of two signal levels (e.g., “0” and “1”) divided by the sum of the noise rms values at the two signal levels.

The Q-factor may be determined by a variety of different techniques, two of which are referred to as the histogram method and the pseudo-BER method. Q-factor monitors employing one or more of these techniques are commercially available from the Acterna Corporation, for example.

Instead of the Q-factor the optical interface devices 150 may employ other techniques to access signal quality. Simplest of all, an optical spectrum analyzer may be used to display the signal spectrum provided from the transmission line by a wide band optical tap. While this is not a definitive measure of signal quality since no time domain information is available from the spectrum, it can give basic information. For example, the signal spectrum can be used to determine the presence or absence of individual channels, signal levels, and the spectral width of the individual channels.

Signal quality may also be assessed by measuring the optical signal-to-noise ratio or by providing an optical receiver with a tunable filter in the optical interface devices 150. In this latter case the FEC overhead bits generally incorporated with the payload data can be directly monitored to count the number of errors that arise.

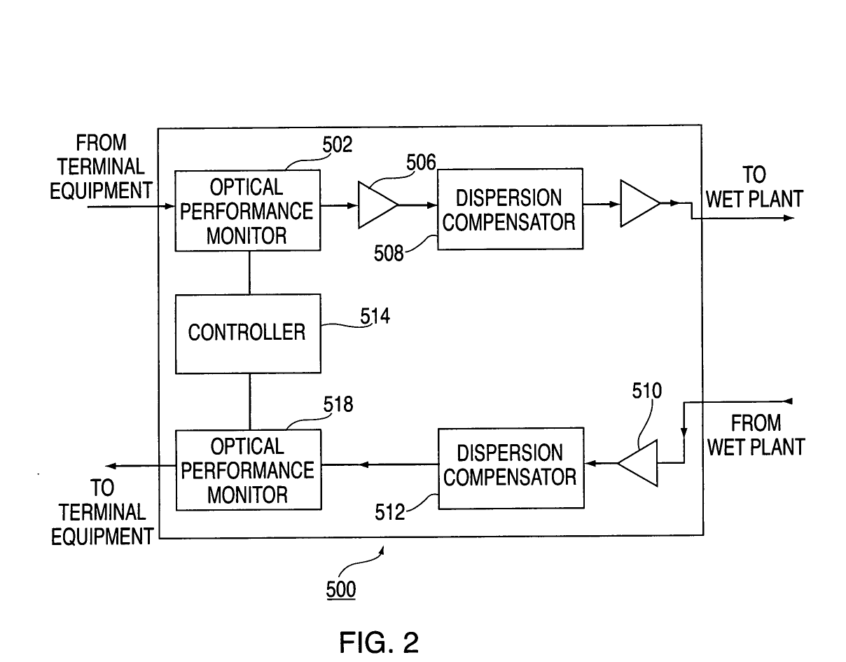

FIG. 2 shows a block diagram of one embodiment of optical interface device 500 that may be employed in the present invention. Under control of a controller 514, the optical signal received from the terminal equipment is monitored for optical performance by optical performance monitor 502, then optically amplified by amplifier 506, and passed through a dispersion compensation device 508 such as a dispersion compensating fiber or a grating-based dispersion compensation device, after which the optical signal is ready to traverse the undersea optical transmission path. Likewise, the optical signal received by the interface device 500 from the undersea optical transmission path is optically amplified by amplifier 510, passed through a dispersion compensation device 512, and monitored for performance by optical performance monitor 518. Optical performance monitors 502 and 518 monitor signal quality between interfaces 164 and 174 (see FIG. 1). In some cases the optical performance monitors 502 and 518 may also monitor the health and status of the wet plant, as discussed in the aforementioned U.S. patent application Ser. No. 10/621,115.

1. A method for monitoring optical signal quality between land-based terminal equipment and an undersea optical transmission path, said method comprising the steps of:
receiving an analog optical signal in which information is embodied in digital form from either of the terminal equipment or the undersea optical transmission path; and
measuring a parameter reflecting signal quality by analysis of the analog optical signal and not the information digitally embodied therein.

2. The method of claim 1 wherein said parameter is a Q-factor.

3. The method of claim 1 wherein said parameter comprises a signal spectrum.

4. A method for providing optical-level connectivity between land-based terminal equipment and an undersea optical transmission path, said method comprising the steps of:
receiving an analog optical signal in which information is embodied in digital form from the terminal equipment;
measuring a parameter reflecting signal quality by analysis of the analog optical signal and not the information digitally embodied therein;
performing at least one optical-level signal process on the analog optical signal; and
directing said analog optical signal onto the undersea optical transmission path.

5. The method of claim 4 wherein said optical-level signal process is selected from the group consisting of gain equalization, bulk dispersion compensation, optical gain, Raman amplification, dispersion slope compensation., PMD compensation, and dummy channel insertion.

6. The method of claim 4 wherein said parameter is a Q-factor.

7. The method of claim 4 wherein said parameter comprises a signal spectrum.

8. The method of claim 4 further comprising the step of supplying Raman amplification to the analog optical signal.

9. The method of claim 4 further comprising the step of monitoring a status of the undersea optical transmission path.

10. The method of claim 4 wherein said monitoring step is performed with a COTDR.

11. The method of claim 9 wherein said monitoring step employs an autocorrelation technique.

12. An optical interface device for providing optical-level connectivity between land-based terminal equipment and an undersea optical transmission path, comprising:
means for receiving an analog optical signal in which information is embodied in digital form from the terminal equipment;
means for measuring a parameter reflecting signal quality by analysis of the analog optical signal and not the information digitally embodied therein;
means for performing at least one optical-level signal process on the analog optical signal; and
means for directing said analog optical signal onto the undersea optical transmission path.

13. The optical interface device of claim 4 wherein said optical-level signal process is selected from the group consisting of gain equalization, bulk dispersion compensation, optical gain, Raman amplification, dispersion slope compensation., PMD compensation, and dummy channel insertion.

14. The optical interface device of claim 12 wherein said parameter is a Q-factor.

15. The optical interface device of claim 12 wherein said parameter comprises a signal spectrum.

16. The optical interface device of claim 12 further comprising means for supplying Raman amplification to the analog optical signal.

17. The optical interface device of claim 12 further comprising means for monitoring a status of the undersea optical transmission path.

18. The optical interface device of claim 17 wherein said monitoring means comprises a COTDR.

19. The optical interface device of claim 17 wherein said monitoring means comprises an autocorrelation arrangement.
